(19) United States
(12) Patent Application Publication
(10) Pub. No.: US 2006/0266171 A1
(43) Pub. Date: Nov. 30, 2006

(54) Davenport multi-spindle automatic screw machine, and rear worm drive shaft for use therein

(75) Inventors: James Hugick, Rochester, NY (US); Brian A. Guess, Pittsford, NY (US); David R. Caporale, Churchville, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Davenport Machine, Inc.

(21) Appl. No.: 11/139,830

(22) Filed: May 27, 2005

(51) Int. Cl. B23B 1/00

(52) U.S. Cl. 82/110

(57) ABSTRACT

A rear worm drive shaft (60) for a Davenport® multi-spindle automatic screw machine, comprises: a shaft first part (61) having a portion with a first hardness; a shaft second part (62) having a portion with a second hardness, said second hardness being greater than the first hardness; and a coupling (63) adapted to join the shaft first and second parts in an axially-aligned relation and to prevent relative rotation therebetween. The improved shaft may be changed on a Davenport® screw machine is about one-half hour.

### TECHNICAL FIELD

The present invention relates generally to Davenport® multi-spindle automatic screw machines, and, more particularly, to improved Davenport® screw machines that incorporate an easy-to-change rear worm drive shaft, and to improved rear worm drive shafts for use therein.

### BACKGROUND ART

A screw machine is a machine tool in which a tool is selectively moved to an engage a rotating workpiece.

A Davenport® multi-spindle automatic screw machine (Davenport® is a registered trademark of, and such machines are available from, Davenport Machine, Inc., 167 Ames Street, Rochester, N.Y. 14611) typically has five workpiece-holding spindles that are rotatably indexable from station to station. At each station, a tool is adapted to be selectively moved to engage a rotating workpiece held in the proximate spindle. The tools are carried by tool arms that are pivotally mounted on the revolving head cap of the screw machine. These tool arms are adapted to be selectively moved relative to the head cap at each station to cause the particular tool held therein to perform a specific machining operation on the relatively-rotating workpiece. Due to their popularity, versatility and adaptability, these machines are in widespread use today, and are frequently rebuilt or upgraded to continue, restore and/or improve their performance.

In such a Davenport® machine, a rear worm drive shaft is used to transfer power and motion from the main electric drive motor to front and rear worm gears that rotate cam shafts in the machine. Heretofore, a greatly-elongated one-piece shaft has been used as the rear worm drive shaft. This shaft has a length-to-diameter ratio on the order of about 33:1, is costly to manufacture, and is formed of a material having properties that are a compromise of those needed on different regions of the shaft. In fact, with this large length-to-diameter ratio, the prior art shaft had to be manufactured on a Swiss turning machine. In addition, the shaft was turned from bar or round stock. To provide an integral outwardly-extending annular flange, over two-thirds of the original stock had to be removed. Moreover, when the shaft would fail (e.g., as by torsion), one portion of the shaft would need to be replaced, while other portions would be unaffected by the particular source of failure. Thus, the shaft was difficult and costly to manufacture and form.

Another problem lay in the mounting of such shaft in the Davenport® screw machine. It could take as long as about eight hours to replace a prior art unitary rear worm drive shaft. The shaft had to be replaced in the event of a shaft failure. However, with the prior art arrangement, the shaft also had to be removed from the machine to service various add-on components (i.e., chucking unit, high speed clutch, etc.) that were mounted on, or otherwise engaged, the shaft. If these components were not timely serviced, the production of the entire machine could be degraded. Moreover, this prior art shaft was typically formed of high-carbon alloy steel. This material was selected so as to balance torsional strength against hardness at various points of contact with other structure. In other words, this material were selected because they were a practical compromise between torsional strength and hardness.

Accordingly, there has been a long standing need to provide an improved rear worm drive shaft for use in such a Davenport® machine that would be less costly to manufacture; that would require less sophisticated machinery to manufacture; that could be removed from, or installed on, the machine in a shorter period of time, regardless of whether such removal was mandated by a failure of the shaft, or by a need to service bolt-on components; and that would allow replacement of only a failed portion of the shaft.

### DISCLOSURE OF THE INVENTION

With parenthetical reference to the corresponding parts, portions or surfaces of the disclosed embodiment, merely for purposes of illustration and not by way of limitation, the present invention broadly provides an improved Davenport® multi-spindle automatic screw machine that incorporates an improved rear worm drive shaft, and a rear worm drive shaft for use in such a machine.

In one aspect, the invention broadly provides a rear worm drive shaft (60) for a Davenport® multi-spindle automatic screw machine, which comprises: a shaft first part (61) having a portion (44) with a first hardness; a shaft second part (62) having a portion (21, 23, 24, 25, 26, 28) with a second hardness, the second hardness being greater than the first hardness; and a coupling (63) adapted to couple or join the shaft first and second parts in an axially-aligned relation and to prevent relative rotation therebetween.

The first part portion may (61) have a hardness of about 15-20 on a Rockwell “C” scale, and may be formed of a suitable low-carbon plain steel.

The second part portion (62) may have a hardness of about 32 on a Rockwell “C” scale, and may be formed of a suitable high-carbon alloy steel. The second part portion may be a surface of the second part that has been hardened, as by flame-hardening, induction-hardening, case-hardening, plating, or the like.

The first and second parts may have cooperative keyways (66, 73), and a key may be operatively arranged in these keyways to prevent relative rotation between the shaft first and second parts.

Each of the first and second parts may have a length-to-diameter ratio of not more than about 20:1.

In another aspect, the invention provides an improved Davenport® multi-spindle automatic screw machine that has a multi-part rear worm drive shaft, the drive shaft being so configured and arranged as to permit the shaft to be removed form the screw machine in about one-halfhour. In the preferred embodiment, the drive shaft is formed in sections and the time needed to change such sectional drive shaft is less than about one-tenth, and, in some cases, as low as one-sixteenth, of the time needed to change a non-sectional unitary drive shaft of the same material dimensions.

Accordingly, the general object of the invention is to provide an improved Davenport® multi-spindle automatic screw machine.

Another object is to provide an improved rear worm drive shaft for use in a Davenport® multi-spindle automatic screw machine.

Another object is to provide an improved sectional rear worm drive shaft for use in a Davenport® multi-spindle automatic screw machine, that allows the drive shaft to be changed in less than about one-tenth, and, in some cases, as low as about one-sixteenth, of the time needed to change a non-sectional unitary drive shaft of the same material dimensions.

Another object is to provide an improved sectional rear worm drive shaft for use in a Davenport® multi-spindle automatic screw machine, that is less costly to manufacture, and that allows only the failed portion of such shaft to be replaced.

These and other objects and advantages will become apparent from the foregoing and ongoing written specification, the drawings and the appended claims.

### BRIEF DESCRIPTION OF THE DRAWINGS

FIG. 1 is a side elevation of a prior art rear worm drive shaft for use in a Davenport® multi-spindle automatic screw machine.

FIG. 2 is a left end elevation of the rear worm drive shaft shown in FIG. 1.

FIG. 3 is a right end elevation of the rear worm drive shaft shown in FIG. 1.

FIG. 4 is a bottom view of the rear worm drive shaft shown in FIG. 1.

FIG. 5 is an greatly-enlarged detail view of the leftward groove, this view being taken within the indicated area of FIG. 4.

FIG. 6 is a greatly-enlarged detail view of the rightward groove, this view being taken within the indicated area of FIG. 4.

FIG. 7 is a side elevation of the second part of an improved rear worm drive shaft for use in a Davenport® multi-spindle automatic screw machine.

FIG. 8 is a left end elevation of the drive shaft second part shown in FIG. 7.

FIG. 9 is a right elevation of the drive shaft second part shown in FIG. 7.

FIG. 10 is a bottom plan view of the drive shaft second part shown in FIG. 7.

FIG. 11 is a greatly-enlarged detail view of the leftward groove of the drive shaft second part, this view being taken within the indicated area of FIG. 10.

FIG. 12 is a side elevation of the first part of an improved rear worm drive shaft for use in a Davenport® multi-spindle automatic screw machine, this view being shown in exploded aligned relation to the drive shaft second part shown in FIG. 7.

FIG. 13 is a left end view of the drive shaft first part shown in FIG. 12.

FIG. 14 is a right end view of the drive shaft shown in FIG. 12.

FIG. 15 is a bottom plan view of the drive shaft shown in FIG. 12.

FIG. 16 is a greatly enlarged detail view of the rightward groove, this view being taken within the indicated area of FIG. 15.

FIG. 17 is a perspective view of a first form of split coupling for joining the first and second shaft parts.

FIG. 18 is a left end elevation of the split coupling shown in FIG. 17.

FIG. 19 is a vertical sectional view thereof, taken generally on line 19-19 of FIG. 18.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

The present invention broadly provides an improved Davenport® multi-spindle automatic screw machine that incorporates an improved rear worm drive shaft, and an improved rear worm drive shaft per se for use in such a machine. However, before proceeding, it is deemed advisable to review the structure of an integrally-formed prior art rear worm drive shaft.

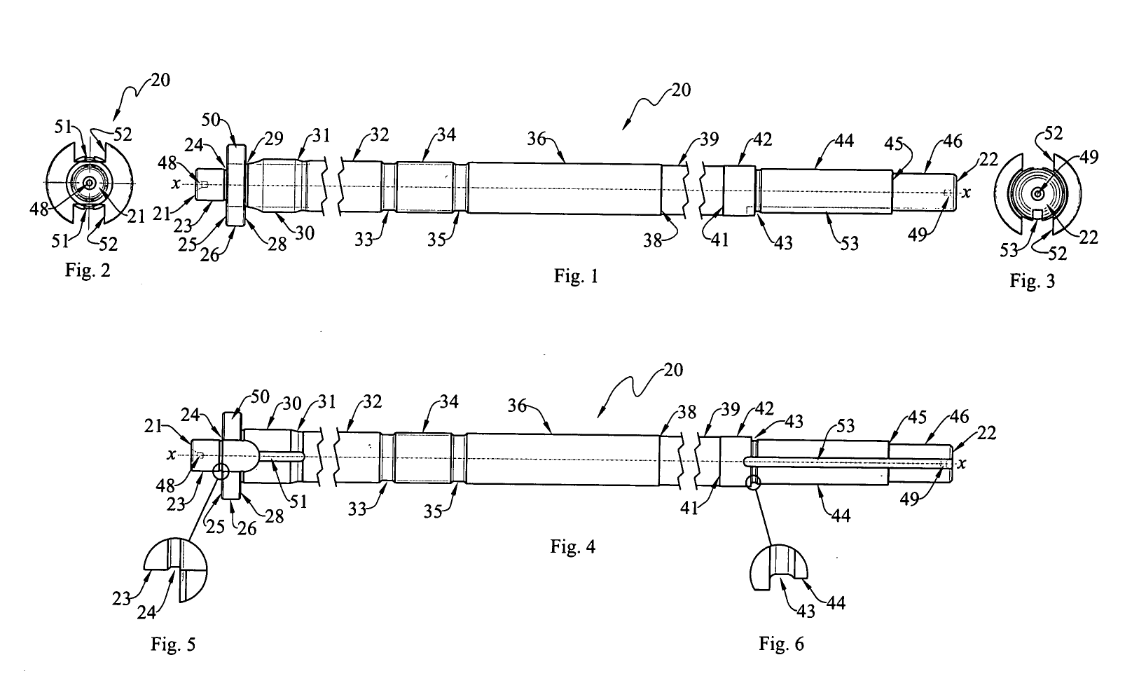

Prior Art Rear Worm Drive Shaft (FIGS. 1-6)

Referring now to the drawings, and, more particularly, to FIGS. 1-6 thereof, a prior art integrally-formed rear worm drive shaft is generally indicated at 20. This drive shaft was formed from a single piece of bar stock, typically a suitable high-carbon alloy steel. Over two-thirds of the weight and volume of the original piece of bar stock was removed to form the one-piece drive shaft 20 shown in FIG. 1.

Drive shaft 20 is shown as having an annular vertical left end face 21, an annular vertical right end face 22, an outer surface that sequentially includes (from left-to-right in FIGS. 1 and 4-6) extending rightwardly from the outer margin of left end face 21, a horizontal cylindrical surface 23, an annular recess 24, a leftwardly-facing annular vertical surface 25, an outwardly-facing horizontal cylindrical surface 26, a rightwardly-facing annular vertical surface 28, another annular recess 29, a horizontal cylindrical surface 30, a rightwardly- and outwardly-facing frusto-conical surface 31, a horizontal cylindrical surface 32, a shallow annular groove 33, an externally-threaded portion 34, another shallow annular groove 35, a horizontal cylindrical surface portion 26, a rightwardly-facing annular vertical shoulder 38, a horizontal cylindrical surface 39, a leftwardly-facing annular vertical surface 41, a horizontal cylindrical surface 42, an annular groove 43, a horizontal cylindrical surface 44, a rightwardly-facing annular vertical surface 45, and an externally-threaded portion 46 continuing rightwardly therefrom to join the outer margin of right end face 22. Blind holes 48, 49 extend axially into the shaft from its left and right end faces 21, 23, respectively, to facilitate the mounting of this workpiece on a Swiss turning machine when the shaft is formed.

The overall length of the shaft is on the order of about 33.34 inches. The diameter of central cylindrical surface 36 is about 1 inch. Hence, this shaft had a length-to-diameter ratio on the order of about 33:1, which required that it be formed on a Swiss turning machine that was capable of handling such an elongated workpiece. Surfaces 25, 26, 28 formed an outwardly-extending annular flange, generally indicated at 50. Two diametrically-opposite keyways, severally indicated at 51, extend along portions 30, 31 to receive keys (no shown) by which the shaft may be rotatably coupled to other structure (not shown). The flange is shown as having two diametrically-opposite rectangular recesses, severally indicated at 52, that are generally aligned with keyways 51, 51. Another keyway, indicated at 53, extends leftwardly into the shaft from its right face and opens onto shaft surface 42.

As previously noted, this particular form of rear worm drive shaft was difficult and costly to manufacture from a single piece of bar stock. First, it required special machinery (i.e., a Swiss turning machine) to accommodate the 33:1 length-to-diameter ratio. Secondly, because of the transverse dimension of flange 50, a greater amount of material had to be removed from the bar stock so as to leave the resulting form.

Improved Rear Worm Drive Spindle (FIGS. 8-16)

The present invention broadly provides an improved rear worm drive shaft, generally indicated at 60, for use in a Davenport® multi-spindle automatic screw machine. The improved drive shaft has a first part 61 and a second part 62. The two parts are joined and operatively coupled by means of a coupling 63.

In the following description, like reference numerals will be used to again refer to structure previously described.

Shaft second part 62 is shown as being a solid member that is horizontally elongated along axis x-x. Whereas the prior art shaft 20 at a large length-to-diameter ratio of about 33:1, the length-to-diameter ratio of shaft second part 62 is about 13:1. This permits the shaft second part to be manufactured on conventional lathes and turning equipment. Here again, the shaft second part is formed by turning an appropriately-sized piece of bar or round stock. Shaft second part 62 is shown as having an annular vertical left end face 21, an annular vertical right end face 64, and an outer surface that sequentially includes (from left-to-right): a horizontal cylindrical surface 23 extending rightwardly from left end face 21, an annular groove 24, a leftwardly-facing annular vertical surface 25, a horizontal cylindrical surface 26, a rightwardly-facing annular vertical surface 28, another annular groove 29, a cylindrical surface portion 30, an outwardly- and rightwardly-facing frusto-conical surface 31, a horizontal cylindrical surface 32, an annular groove 33, an externally-threaded portion 34, another annular groove 35, and a surface 36 continuing rightwardly therefrom to join right end face 64. Blind holes 48, 65 extend into the shaft second part from its left and right end faces 21, 64, respectively, for use in positioning the shaft second part on a lathe or turning machine.

At its left end, the shaft second part has a pair of diametrically-opposite keyways, severally indicated at 51, that extend through portion 30, and that are aligned with diametrically-opposite rectangular slots 52, 52. Another keyway, indicated at 66 is shown as extending leftwardly into shaft second part 62 from its right end face 64. The function of keyway 66 is to receive and accommodate a portion of a key (not shown), by means of which the shaft first and second parts may be rotatably coupled. Surfaces 25, 26, 28 define a flange 50 therebetween.

Referring now to FIGS. 12-16, the shaft first part is shown as being a horizontally-elongated specially-configured solid member having an axis x-x. Shaft first part 61 is shown as having an annular vertical left end face 68, an annular vertical right end face 22, and an outer surface which sequentially includes (from left-to-right in FIG. 12): a horizontal cylindrical surface portion 69 (which is of substantially the same diameter as surface portion 36) extending rightwardly from left end face 68, a rightwardly-facing annular vertical surface 70, an annular groove 71, a horizontal cylindrical surface 44, a rightwardly-facing annular vertical surface 45, and a horizontal cylindrical surface 46 continuing rightwardly therefrom to join right end face 22. Blind locating holes 72, 49 extend axially into the shaft from its left and right end faces 68, 22, respectively, to facilitate the mounting of the shaft on a suitable lathe or turning tool. A keyway 73 extends into the shaft from its left end face and opens onto shaft surface 69. Another keyway 74 extends leftwardly into the shaft from its right end face 22, and opens onto surfaces 46, 44 and 69. The shaft first part as a length-to-diameter ratio of about 20.

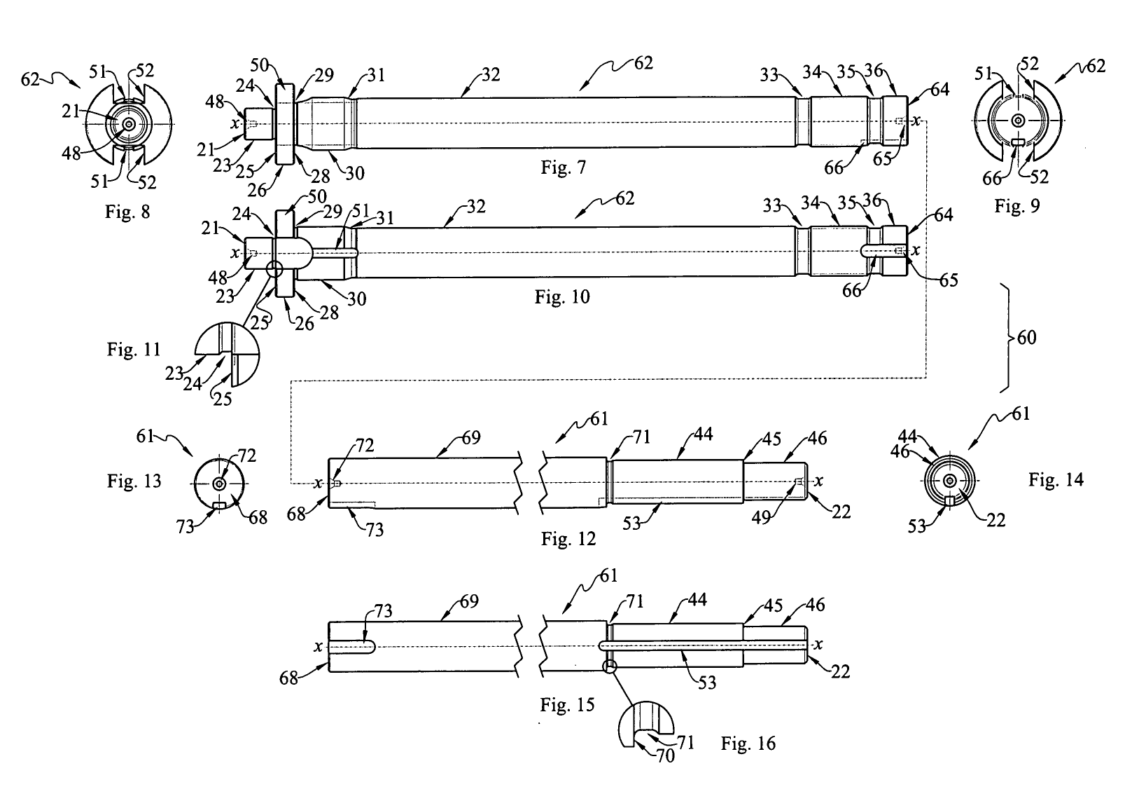

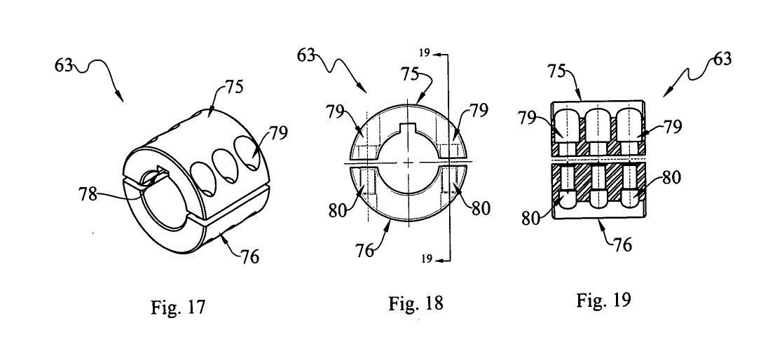

As indicated in FIGS. 7 and 12, the left end of shaft first part of 61 is adapted to be axially aligned with the right end of shaft second part 64, with their respective end faces abutting one another. Thereafter, a sectional coupling, shown in FIGS. 17-19, is clamped to the adjacent marginal end portions of the two shafts.

Coupling 63 is a commercially-available split coupling having an upper part 75 and a lower part 76. Each coupling half has a substantially thin-walled semi-cylindrical shape, when viewed in end elevation. The coupling upper part is shown as having a keyway 78. When the coupling is mounted on the two adjacent shaft parts, the coupling is arranged to receive and accommodate a portion of the key (not shown) that is also received in keyway 53. Thus, the key (not shown) engages keyways 53 and 78. Thereafter, a plurality of fasteners (not shown) are provided through coupling passages 79, and are matingly received in tapped hole 80. Hence, these fasteners may be selectively tightened to draw the two coupling halves together, thereby forming a rigid assembly.

Thus, applicant has formed a sectional rear worm drive shaft that includes the shaft first part, the shaft second part, and the coupling to join these two halves together. This has certain advantages in and of itself. In the prior art, it took something on the order of eight hours to replace the one-piece rear worm drive shaft. While it may take about that length of time to remove the one piece rear worm drive shaft, once it has been replaced with the improved multi-piece rear worm coupling shaft, it may thereafter be changed in as little as about one-half hour. In other words, the improved rear worm drive shaft may be changed in about less than one-tenth of the time needed to change a one-piece drive shaft of the same material dimensions. In fact, the change time may be on the order of one-sixteenth of that required by the prior art. Moreover, the improved rear worm drive shaft avoids the long length-to-diameter ratio, that required the use of special machinery (i.e., a Swiss turning machine) to form it. In addition, whereas the entire one-piece coupling shaft was formed from a single length of bar stock, Applicant forms the improved coupling first and second parts from two different pieces of bar stock. The first coupling part may start with bar stock of a smaller diameter. Hence, less material will have to be removed therefrom.

Another advantage is that the improved sectional rear worm drive shaft may be formed of different materials. With the prior art arrangement, the entire shaft was formed from a single piece of high-carbon alloy steel. This material had a hardness of about 15-20 on a Rockwell “C” scale. In effect, the shaft was formed of a material having properties that were a compromise between a number of different design criteria. On the one hand, the shaft had to have sufficient resistence to torsion. On the other hand, portions of the shaft engage other structure. It would be desirable for these portions to be hardened so as to minimize wear.

In the improved two-piece drive shaft, the shaft second part may be formed of high-carbon alloy steel. However, the left marginal end portion of the shaft second part may be induction-, flame- or case-hardened, or plated, to have a surface hardness on the order of 35-45 on a Rockwell “C” scale. The shaft first part may be formed of low-carbon plain steel to provide greater torsional strength, and have, or be hardened to have, a minimum hardness of about 15-20 on a Rockwell “C” scale.

Therefore, the present invention broadly provides an improved rear worm drive shaft for a Davenport® multi-spindle automatic screw machine that broadly includes a shaft first part formed of one material and having a portion of a first hardness; a shaft second part possibly formed of a second material and having a portion of a second hardness, the second hardness being greater than the first hardness; and a coupling adapted to couple the shaft first and second parts in an axially-aligned relation and to prevent relative rotation therebetween.

As previously noted, the time to change the improved shaft is on the order of one-half hour, as compared with eight hours for the prior art arrangement. Moreover, the improved shaft is easier and less expensive to manufacture, and does not require the use of speciality equipment. In addition, the two parts can be respectively formed of materials specifically tailored to their respective individual uses and functions.

Modifications

The present invention contemplates that many changes and modifications may be made. For example, while the materials of construction may be changed or modified, as desired. Secondly, while it is generally desirable that the multi-part drive shaft simulate a one-piece rear worm drive shaft, the improved drive shaft parts may be configured differently, as desired. Portions of either shaft part may be suitably hardened, as by induction-hardening, flame-hardening, case-hardening, plating or the like, to provide a higher level of surface hardness.

The illustrated form of coupling is only one particular species example of a larger generic class of suitable couplings, with or without key-keyway connections.

Therefore, while the presently-preferred form of the improved rear worm drive shaft has been shown and described, and some modifications thereof discussed, persons skilled in this art will readily appreciate that various addition changes and modifications may be made without departing from the spirit of the invention, as defined and differentiated by the following claims.

What is claimed is:

1. A rear worm drive shaft for a Davenport® multi-spindle automatic screw machine, comprising:
a shaft first part having a portion with a first hardness;
a shaft second part having a portion with a second hardness, said second hardness being greater than said first hardness; and
a coupling adapted to couple said shaft first and second parts in an axially-aligned relation and to prevent relative rotation therebetween.

2. A rear worm drive shaft for a Davenport® multi-spindle automatic screw machine as set forth in claim 1 wherein said first part portion has a hardness of about 15-20 on a Rockwell C scale.

3. A rear worm drive shaft for a Davenport® multi-spindle automatic screw machine as set forth in claim 1 wherein said first part is formed of a low-carbon plain steel.

4. A rear worm drive shaft for a Davenport® multi-spindle automatic screw machine as set forth in claim 1 wherein said second part portion has a hardness of about 32 on a Rockwell C scale.

5. A rear worm drive shaft for a Davenport® multi-spindle automatic screw machine as set forth in claim 1 wherein said second part is formed of a high-carbon alloy steel.

6. A rear worm drive shaft for a Davenport® multi-spindle automatic screw machine as set forth in claim 1 wherein said second part portion is a surface of said second part which has been hardened.

7. A rear worm drive shaft for a Davenport® multi-spindle automatic screw machine as set forth in claim 1 wherein said first and second parts have keyways, and wherein a key is operatively arranged in said keyways to prevent relative rotation between said shaft first and second parts.

8. A rear worm drive shaft for a Davenport® multi-spindle automatic screw machine as set forth in claim 1 wherein each of said first and second parts has a length-to-diameter ratio of not more than about 20.

9. A Davenport® multi-spindle automatic screw machine having a multi-part rear worm drive shaft, said drive shaft being so configured and arranged as to permit said shaft to be removed form said screw machine in about one-half hour.

10. A Davenport® multi-spindle automatic screw machine as set forth in claim 8 wherein said drive shaft is formed in sections and wherein the time needed to change such sectional drive shaft is less than about one-tenth of the time needed to change a non-sectional drive shaft of the same material dimensions.

11. A Davenport® multi-spindle automatic screw machine as set forth in claim 9 wherein the time needed to change said sectional drive shaft is less than about one-sixteenth of the time needed to change a non-sectional drive shaft of the same material dimensions.
